(19) United States
(12) Patent Application Publication
(10) Pub. No.: US 2007/0132308 A1
(43) Pub. Date: Jun. 14, 2007

(54) Hydrodynamic retarder

(75) Inventors: Klaus Vogelsang, Crailsheim (DE); Heinz Höller, Crailsheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Voith Turbo GmbH & Co.,KG

(21) Appl. No.: 10/572,030

(22) PCT Filed: Jul. 9, 2004
(86) PCT No.: PCT/EP04/07545

§ 371 Date: Feb. 8, 2007

(30) Foreign Application Priority Data
Sep. 13, 2003 (DE) 103 42 400.8

(51) Int. Cl. B60T 13/74; B66D 5/26

(52) U.S. Cl. 303/3; 188/151 R

(57) ABSTRACT

A hydrodynamic retarder having a toroidal working chamber formed from a rotor impeller and a stator impeller. The stator impeller has a stator housing with a substantially ring-shaped evacuation channel formed in the stator housing. The stator impeller has a plurality of boreholes, which join the toroidal working chamber to the evacuation channel.

The present invention concerns a hydrodynamic retarder, especially a water retarder, i.e., a retarder, whose working medium is water or a mixture containing water, in particular, a water-glycol mixture, which is used in the cooling circuit of a vehicle. The invention also concerns a motor vehicle drive having such a retarder.

Retarders and motor vehicle drives or drivelines with retarders are widely known and find widespread use. The retarder, also named hydrodynamic brake, is used in order to brake vehicles and also stationary equipment in a manner that limits wear. By an arrangement of two adjacent impellers facing one another, i.e, a driven rotor impeller and a stationary stator impeller, a toroidal working chamber is formed, in which a working medium forms a flow circuit, by means of which drive torque is transmitted to the stationary stator impeller.

Prior development effort has principally dealt with optimizing power and structural dimensions. Therefore, a plurality of measures are known at the present time, wherein the power consumption of the retarder can be maximized during braking operation and minimized during idling. In addition, today's retarders have an extremely small structural size, so that they can be disposed taking up little space in a vehicle where there is increasingly less space available for the retarder. But up to today, however, one has hardly dealt with dissipating the buildup of noise in retarders, particularly during braking operation with increased power. Due to the small noise emissions of vehicle drivelines, as they are known at the present time, it is necessary to also reduce the noise emission of retarders, in order to make possible, for example, a high traveling comfort in a vehicle having a retarder, particularly when transporting passengers. In particular, so-called water retarders with increased power are extremely loud during braking operation.

The object of the invention is to present a retarder, especially a water retarder, whose noise emission is minimized especially during braking operation when compared with solutions of the prior art. Further, a design will be presented, which can be manufactured in a cost-favorable manner.

This object is solved by a hydrodynamic retarder with the features of claim 1 or by a driveline with a retarder according to claim 7, respectively. The dependent claims describe particularly advantageous enhancements of the invention.

The inventors have recognized that, in particular, the configuration of the evacuation channel of a retarder has effects on the emission of noise. Therefore, they have developed a shape for the evacuation channel which has proven especially favorable with respect to a minimal emission of noise. The evacuation channel is configured as a ring-shaped channel in the stator housing of the retarder and basically has a channel width which amounts to 0.2 to 0.4 times the profile diameter of the rotor impeller. The profile diameter of the rotor impeller, which especially corresponds to the profile diameter of the stator impeller, is understood to be the outer diameter of the blade profile of a rotor blade.

It is particularly advantageous if the channel height of the evacuation channel substantially amounts to 0.1 to 0.2 times the profile diameter of the rotor impeller. Further, a channel width of the evacuation channel of 0.3 times and, in particular, of 0.35 times the profile diameter of the rotor impeller has proven favorable.

The term “substantially” in the dimensioning of the channel height or of the channel width, respectively, means that the evacuation channel has a channel width, in particular throughout its extent, which amounts to 0.2 to 0.4 times the profile diameter of the rotor impeller. The same is true for the channel height, which preferably amounts to 0.1 to 0.2 times the profile diameter of the rotor impeller over its entire course. Embodiments are also conceivable, however, in which the channels are beveled at one end, so that the entire channel width or the entire channel height, respectively, does not have the indicated fraction of the profile diameter. These constructions will also be encompassed by the design of the evacuation channel according to the invention.

Noise emission can also be positively influenced by a suitable selection of the material at least for the walls of the evacuation channel. Materials which were selected from the following group are advantageous based on their damping behavior.
Nonferrous materials
Plastics (advantageously resistant to temperature and pressure changes in the range of use)
   Either the entire wall structure of the evacuation channel or only the surface of the evacuation channel that contacts the flow can be formed by such a material. In addition, in one particular construction, the entire stator housing can be formed with such a material.

In particular, a combination of the above-named features and the design of the retarder as a water retarder, i.e., the working medium is water or a water mixture, including a water-glycol mixture, is accompanied by a clear optimization of noise [reduction] when compared with known constructions. Further, a minimizing of the noise emissions can be achieved by also taking into consideration the arrangement of the retarder, for example, in a driveline of a motor vehicle. It is particularly advantageous if the retarder is mounted in a motor vehicle drive on the drive side, on the transmission. In this way, the circumstance can be largely avoided that the transmission acts as a resonator for noise emissions of the retarder. Such a retarder can also be called a secondary water retarder.

The invention will be described below in more detail on the basis of the appended FIGURE.

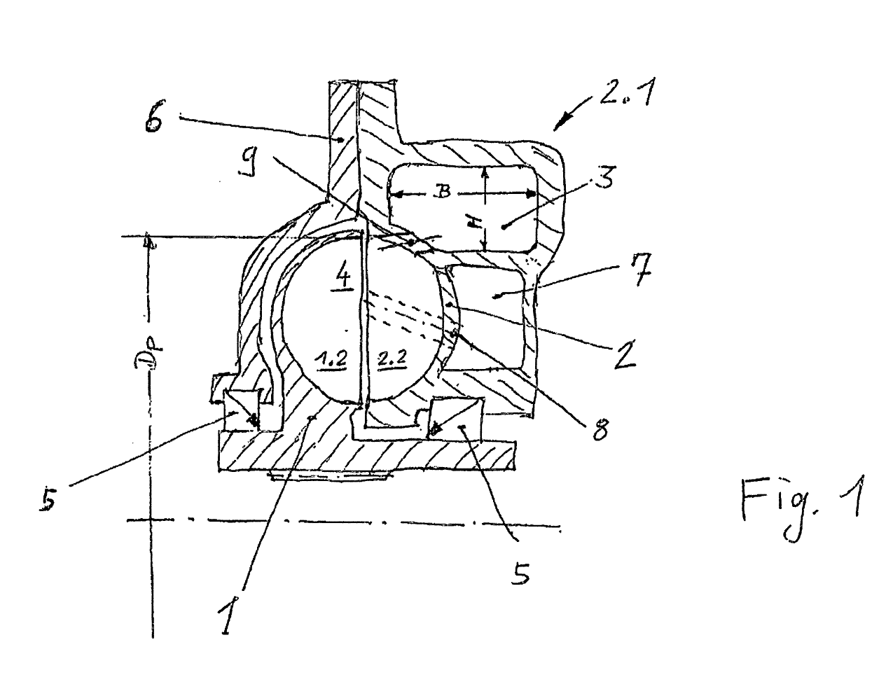

FIG. 1 shows a cross section through a water retarder with an evacuation channel and a filling channel, which are constructed in the stator housing.

The retarder shown in FIG. 1 has a working chamber 4, which is formed by a rotor impeller 1 and a stator impeller 2. The rotor impeller 1 has a blade profile 1.2 and the stator impeller 2 has a blade profile 2.2, which are disposed opposite one another in working chamber 4, as is known. The stator impeller 2 is formed in one piece with a stator housing 2.1. In addition, the flow channels formed in the stator housing 2.1, namely a filling channel 7 and an evacuation channel 3, can be recognized. Filling channel 7 and evacuation channel 3 are each formed as ring-shaped channels and are disposed adjacent to one another, and are separated from one another by a wall of the stator housing 2.1.

Rotor impeller 1 is formed integrally with a rotor shaft, which is sealed by gaskets 5 both against the stator housing 2.1 as well as against a housing 6 that surrounds the rotor impeller 1 and is joined with the stator housing 2.1.

The rotor impeller 1 and the stator impeller 2 or the blade profiles 1.2 and 2.2, respectively, each have a profile diameter, which is denoted Dₚ in the figure.

As shown, the evacuation channel has a width in the axial direction of the rotor shaft, which is denoted B and a height in the radial direction of the rotor shaft, which is denoted H. This width B of the evacuation channel and optionally the height H of the evacuation channel are constructed with the indicated dimensions according to the invention, in order to minimize the noise emission.

During braking operation, a working medium, which is advantageously water or a water mixture, reaches working chamber 4 via the filling channel 7. For this purpose, the walls in the stator housing 2.1, which separate the filling channel 7 from the working chamber 4, are provided with boreholes 8, which open up into filling channels in the blade profiles 2.2 of the stator 2, as shown by the dashes. Stator blades with such an introduction channel or slot are also called filling blades. The retarder has a pre-given number of such filling blades; for example, each second blade can be shaped as a filling blade.

From the working chamber 4, the working medium reaches evacuation channel 3 via the boreholes 9 in the walls of the stator housing 2.1 that separate the working chamber from the evacuation channel. Advantageously, this borehole 9 is disposed radially in the region of the profile diameter Dₚ, so that the working medium—as shown—flows substantially or completely onto a radial position, which corresponds to the outer diameter of the blade profile, into the evacuation channel 3. In addition, the flow length of borehole 9 is advantageously made relatively short. Then the working medium flows through evacuation channel 3 in an annular flow. Depending on the velocity of this annular flow and the rate of discharge of the working medium through boreholes 9, the working medium strikes against the wall of the stator housing 2.1 that lies opposite boreholes 9. In addition, a stop piece for the working medium at the radial outer-lying wall of the evacuation channel 3 is also conceivable. Such a stop piece generates knocking noise. The knocking noise can be minimized, however, by the construction of the evacuation channel according to the invention. It is also possible to use inexpensive materials, in particular materials other than metal, which can lead to an additional attenuation of the pinging noise.

### LIST OF REFERENCE NUMERALS

1 rotor impeller
1.2 rotor blade profile
2 stator impeller
2.1 stator housing
2.2 stator blade profile
3 evacuation channel
4 working chamber
5 gasket
6 housing
7 filling channel
8 borehole
9 borehole

1-7. (canceled)

8. A hydrodynamic retarder comprising:
a toroidal working chamber formed from a rotor impeller and a stator impeller;
a stator housing connected to the stator impeller;
an evacuation channel formed in the stator housing, the evacuation channel being substantially ring shaped;
a plurality of boreholes in the stator impeller, the boreholes joining the toroidal working chamber and the evacuation channel.

9. The hydrodynamic retarder of claim 8, wherein the hydrodynamic retarder is a water retarder.

10. The hydrodynamic retarder of claim 8, wherein the evacuation channel has a channel width that is between approximately 20% and approximately 40% of a profile diameter of the rotor impeller.

11. The hydrodynamic retarder of claim 10, wherein the evacuation channel has a channel height that is between approximately 10% and approximately 20% of the profile diameter of the rotor impeller.

12. The hydrodynamic retarder of claim 10, wherein the channel width of the evacuation channel is between approximately 30% and approximately 35% of the profile diameter of the rotor impeller.

13. The hydrodynamic retarder of claim 8, wherein the stator housing is constructed of plastic.

14. The hydrodynamic retarder of claim 8, wherein the stator housing is constructed of a nonferrous material.

15. The hydrodynamic retarder of claim 8, wherein walls of the evacuation channel are constructed of plastic.

16. The hydrodynamic retarder of claim 8, wherein walls of the evacuation channel are constructed of a nonferrous material.

17. The hydrodynamic retarder of claim 8, further comprising a working medium in the toroidal working chamber.

18. The hydrodynamic retarder of claim 17, wherein the working medium is a cooling medium of a motor vehicle cooling circuit.

19. The hydrodynamic retarder of claim 18, wherein the working medium is selected from the group consisting of water and a water-glycol mixture.

20. The hydrodynamic retarder according to claim 8, wherein the hydrodynamic retarder is a secondary retarder.

21. A driveline for a motor vehicle comprising:
a motor;
a transmission connected to the motor;
a hydrodynamic retarder mounted on a drive side of the transmission, the hydrodynamic retarder comprising:
a toroidal working chamber formed from a rotor impeller and a stator impeller;
a stator housing connected to the stator impeller;
an evacuation channel formed in the stator housing, the evacuation channel being substantially ring shaped;
a plurality of boreholes in the stator impeller, the boreholes joining the toroidal working chamber and the evacuation channel.
